(19) United States
(12) Patent Application Publication
(10) Pub. No.: US 2014/0247991 A1
(43) Pub. Date: Sep. 4, 2014

(54) SYSTEM AND METHOD FOR GENERATING MACHINE READABLE MEDIUM

(71) Applicants: Michael Archuleta, Austin, TX (US); Michael Archuleta, II, Austin, TX (US); Austin Archuleta, Austin, TX (US)

(72) Inventors: Michael Archuleta, Austin, TX (US); Michael Archuleta, II, Austin, TX (US); Austin Archuleta, Austin, TX (US)

(21) Appl. No.: 14/182,914

(22) Filed: Feb. 18, 2014

Related U.S. Application Data
(63) Continuation of application No. 13/763,304, filed on Feb. 8, 2013.
Application No. 13/763,304 is a continuation-in-part of application No. 13/633,621, filed on Oct. 2, 2012.

(51) Int. Cl. G06K 1/18; G06K 9/18; G06K 5/00

(52) U.S. Cl. CPC G06K 1/18; G06K 5/00; G06K 9/18
USPC 382/182; 235/375

(57) ABSTRACT

A system and method is provided that enables a business to purchase a generic, but unique, kit containing one or more signs, with a machine readable medium. The computer readable medium stores information relating to a unique web address of a configurable web site landing page. An administrator configures the web site as desired so that when a user scans the machine readable medium, the user will be direct to the web site, and will have access to the content configured by the administrator. A system and method is also provided for programming or generating machine readable medium.

### CROSS REFERENCE TO RELATED APPLICATIONS

This application is a Continuation of U.S. Ser. No. 13/763,304 filed Feb. 8, 2013, which is a Continuation-in-Part of co-pending commonly owned U.S. patent application Ser. No. 13/633,621, attorney docket number ARC.P102, filed on Oct. 2, 2012, entitled “SYSTEM AND METHOD FOR DIRECTING USERS TO WEB CONTENT,” (pending) all of which are incorporated by reference in their entirety.

### FIELD OF THE INVENTION

This disclosure relates to machine readable medium. In particular, this disclosure is drawn to a system for automating the generation of machine readable medium.

### BACKGROUND OF THE INVENTION

It is common for businesses, groups, organizations, clubs, etc., to use social media as a form of promotion, and to communicate with people. Social networking allows businesses to reach out to potential customers without a huge advertising budget, while also staying in touch with current customers.

One challenge for a business using social networks as a promotional tool relates to the difficulty of getting current and potential customers to use social networks to communicate with the business. Typically, a business will provide customers with their social network handle or a URL, and hope the customers take the initiative to use that information to communicate with the business. This process typically results in a low acquisition rate.

### SUMMARY OF THE INVENTION

A method is provided for generating a machine readable medium including reading information from a first machine readable medium, and generating a second machine readable medium using the information read from the first machine readable medium, wherein the second machine readable medium is generated to include information relating to the information read from the first machine readable medium.

Another embodiment provides a method of programming a near field communication (NFC) tag including reading information from an optical barcode relating to the URL of a website, and using the information read from the optical barcode to program an NFC tag with information relating to the URL of the website.

Another embodiment provides a method of verifying the accuracy of information stored on a machine readable medium including reading information from a first machine readable medium, reading information from a second machine readable medium, comparing the information read from the first machine readable medium and the second machine readable medium, and determining whether the information read from the first machine readable medium and the information read from the second machine readable medium relate to a common piece of information.

Another embodiment provides a method of generating a machine readable medium including using optical character recognition (OCR) to scan textual information, and generating a machine readable medium using the scanned textual information, wherein the machine readable medium is generated to include information relating to the scanned textual information.

Other features and advantages of the present disclosure will be apparent from the accompanying drawings and from the detailed description that follows below.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of an example of a system implemented in an internet environment.

FIGS. 2A-2D are diagrams of exemplary screen shots from a web browser, as it would be viewed by a user of a network client.

FIG. 3 is a diagram illustrating one example of a sign, including machine readable medium.

FIG. 4 illustrates one example of the contents of a kit.

FIG. 5 is a flowchart illustrating a process for registering a kit and configuring a web site landing page.

FIG. 6 is a flowchart illustrating a process for reading/scanning a sign and retrieving a web site landing page.

FIG. 7 is a block diagram of an apparatus for reading a first machine readable medium and programming a second machine readable medium.

FIGS. 8A and 8B are flowcharts illustrating processes for programming one machine readable medium based on information read from another machine readable medium.

FIG. 9 is a flowchart illustrating a process for verifying that two or more multiple machine readable medium match.

FIG. 10 is a flow chart illustrating a process for generating unique machine readable medium for a product.

### DETAILED DESCRIPTION OF THE PREFERRED EMBODIMENT

Generally, the present disclosure relates to techniques for linking users to one or more social networks or web sites. In one example, in the context of a business trying to attract current and potential customers to one or more social networks and/or other web sites, the business is provided with unique signs, stickers, decals, cards, etc. Each sign includes one or more machine readable medium that can be read by a mobile device. The machine readable medium stores information, including information relating to a web address that can be accessed by a mobile device. In one example, a mobile device that reads the machine readable medium is directed to a web site landing page configured by an administrator to provide the user of the device with information and links relating to the business. Examples include, but are not limited to, information relating to the business, social networking services, pictures, videos, etc. Once the web site is configured as desired, a business can display the signs, stickers, decals, etc., where current and potential customers can use a mobile device (e.g., a smart phone) to scan the medium and quickly and effortlessly be directed to the online content of the web site. Detailed examples of this and related techniques are described below.

As described above, techniques are disclosed for easily directing users to web content configured by an administrator. In one example, a system is provided that enables a business (or other user) to purchase a generic, but unique, kit containing one or more signs, each with at least one machine readable medium. A generic kit is intended to mean a kit that, while having a unique identifier, is not customized for any particular pre-existing user such that any user can use any kit. In the exemplary implementation described above, the computer readable medium of each kit stores information relating to a unique web address of a configurable web site. An administrator is allowed to configure the web site as desired so that when a user scans the medium, the user will be direct to the web site, and will have access to the content configured by the administrator. This technique eliminates the need for customized signs that have to be configured for a preexisting web address or user account. As a result, a plurality of generic kits can be manufactured inexpensively and can be used by businesses to direct users to a specifically configured web site.

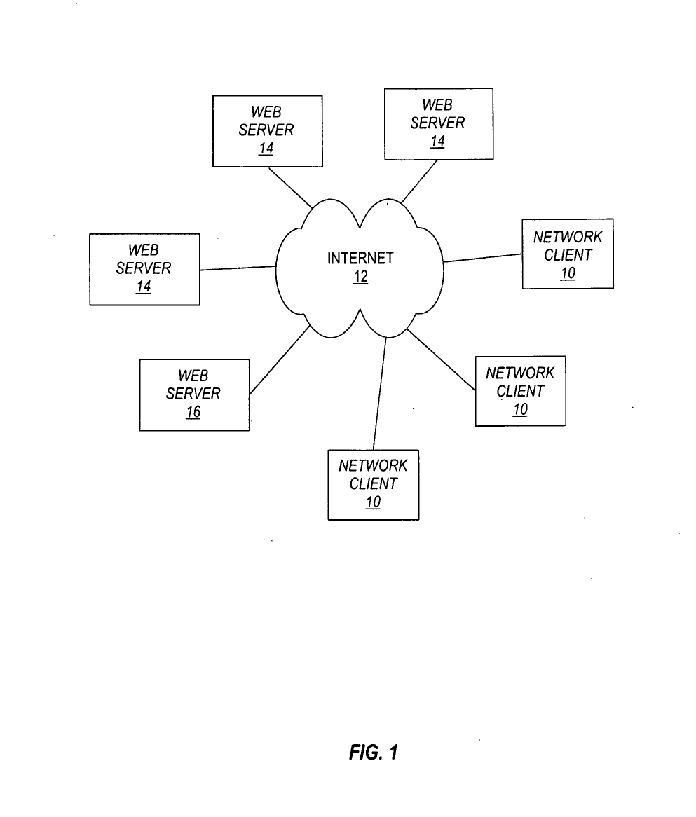

In order to provide a context for understanding this description, the following description illustrates an example of an environment in which the techniques described may be used. FIG. 1 is a block diagram of an example of the present disclosure implemented in a web environment. Note however, that the techniques can also be implemented in other environments. FIG. 1 is a block diagram showing a plurality of network clients 10 coupled to a network (in this example, internet 12). The network clients 10 may be any desired type of client, such as a smart phone, computer, tablet, PDA, network appliance, etc. A typical network client 10 may include a processor(s), a storage device(s) (memory, hard drive, etc.), user interface device (e.g., touch screen, keyboard, keypad, mouse, etc.) and a display.

A plurality of web servers 14 and 16 are also coupled to the internet 12. The web servers 14 and 16 host various web sites, which may be accessed and viewed by internet browsers installed on the network clients 10. When a user of one of the network clients 10 requests a web page hosted by the web servers 14 and/or 16, the web browser of the network client 10 will send a request to the respective web server, and will then retrieve web page content, which is displayed for a user of the network client 10.

As described above, in one example, a kit is provided that includes one or more signs, each with at least one machine readable medium. The machine readable medium stores information relating to a unique web site landing page address hosted by the web server 16 (FIG. 1). The user (e.g., a business owner) of a kit registers the kit by creating and logging into an account. The user is then allowed to configure the layout and content of the web site hosted at the unique web site address in any desired manner to provide desired information and links to current and potential customers that scan the signs.

Examples of web content include, but are not limited to, social networking services, links to web sites, pictures, videos, maps, reviews, surveys, contact information, business hours, wifi information, links to downloadable files, ecommerce tools, application shortcuts, etc. If desired, the web page can be formatted for optimal viewing on a mobile device, PC, tablet, etc. In one example, the web server detects the type of device requesting the web page, and provides the web content in an optimal format.

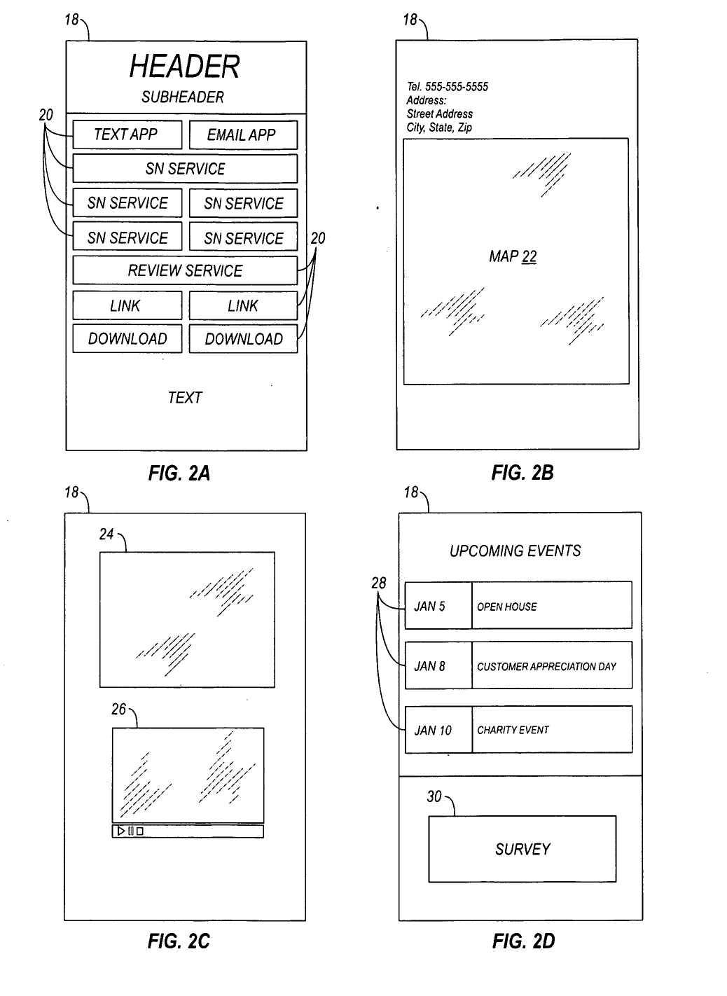

FIGS. 2A-2D are diagrams of exemplary screen shots from a web browser, as it would be viewed by a user of a network client 10. For clarity, menus, buttons, address lines, etc., are not shown in the examples. Note that the following examples are merely a few possible examples of web content, and that many other examples are possible. FIG. 2A is an exemplary screenshot 18 of the web page, including a header and sub-header, as defined by the user that configured the web page. FIG. 2A also shows a plurality of buttons 20 that are configured to provide links to web sites, links to the user's social networking services, links to the user's regular web site, text/email (or other) application shortcuts, file download links, etc. FIG. 2B is an exemplary screenshot 18 of the web page, including information relating to the location of a business, including an interactive map, a physical and/or mailing address, a telephone number, and any other desired contact information. FIG. 2C is an exemplary screenshot 18 of the web page, including one or more pictures 24 and videos 26. If desired, the web site can be configured to allow other users to upload pictures or videos. FIG. 2D is an exemplary screenshot 18 of the web page, including a calendar or listing of upcoming events 28 and a customer survey 30. The examples shown in FIGS. 2A-2D are merely a few examples of content that can be configured to be displayed on the web page. Any other desired layout and content can be displayed.

In the exemplary system described above, a generic, but unique, kit contains one or more signs, which can be used to direct customers to web content. Note that the term “sign” is intended to mean any item capable of being used to display information and/or provide access to a machine readable medium. The signs described can be displayed in any manner desired, such as being attached to a wall, window, or other surface, held upright by a base member, or incorporated with other items such as menus, brochures, etc. Other examples are also possible. In some examples, signs may be made from paper, cardboard, plastic, metal, stickers, decals, window clings, etc.

In one example, each sign includes at least one machine readable medium. As described above, each machine readable medium stores information that can be used to direct a user to web content upon reading or scanning the machine readable medium. For example, a user with a smart phone, tablet, or other portable device can use the device to read the machine readable medium and quickly and easily be directed to a web site landing page, as configured by the administrator. Examples of machine readable medium include optical bar codes (e.g., QR codes), near field communication (NFC) devices, magnetic stripes, smart chips, RFID tags, magnetic ink characters, Bluetooth (or similar wireless devices), etc.

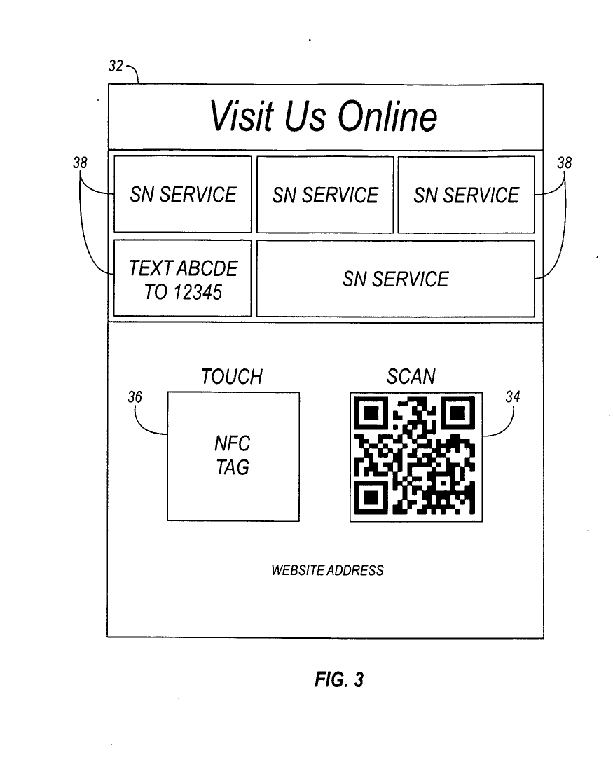

FIG. 3 is a diagram illustrating one example of a sign 32. In this example, the sign 32 includes machine readable medium 34 and 36. The medium 34 is an optical bar code (in this example, a QR code), which can be read by devices having an optical scanner and corresponding software (e.g., using the camera hardware on a smart phone). The medium 36, in this example, is an NFC tag imbedded in or adhered to the sign 32. The NFC tag can be read by a device having the appropriate NFC hardware and software.

When a user scans either medium, the user's device will be directed to a web page, such as the web pages shown in FIGS. 2A-2D. The sign 32 may also include instructions (e.g., “scan” in the case of the bar code or “touch” in the case of an NFC device) directing the user to use a device to read the medium. In this example, the bar code (medium 34) and NFC tag (medium 36) both store information that directs the user to a common URL. Also note that, as described above, each kit is unique, in that when a user reads either medium, the user is directed to a URL that is unique or different from URL's from other kits. One challenge with manufacturing a plurality of kits is that the machine readable mediums on each sign have to be generated or programmed with unique and related information. One solution for making the generation of medium more efficient is described below.

The example of FIG. 3 also includes one or more labels 38 that tell users what information or services are provided or linked on the web page landing page. In one example, the labels 38 are selected from a plurality of pre-printed repositionable labels, allowing the administrator to select and display desired labels. In the example of FIG. 3, the sign 32 uses five labels identifying four different social networking services that are linked on the landing page and one label that relates to a text message campaign (described below). The exemplary sign 32 of FIG. 3 also includes the URL of the web page landing page, allowing a user to access the web page if the user's device is unable to read the machine readable medium. Of course, any other desired information may also be provided on the sign.

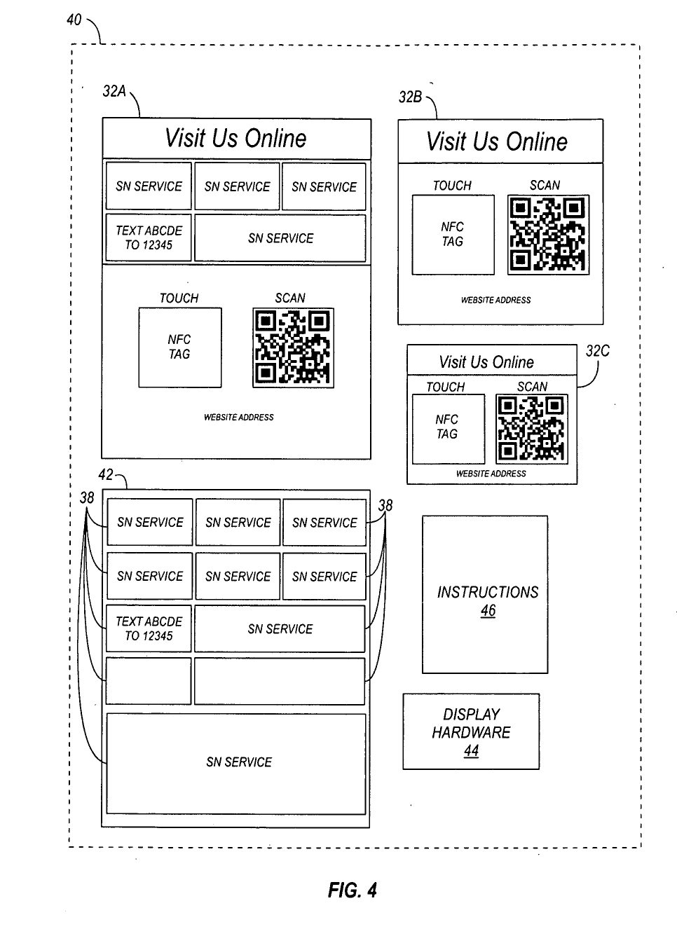

FIG. 4 illustrates one example of the contents of a kit described above. The kit 40 shown in FIG. 4 includes a plurality of signs, each having at least one machine readable medium. FIG. 4 shows a first sign 32A, similar to the sign shown in FIG. 3. In this example a plurality of signs (signs 32A, 32B, 32C) are provided in a variety of sizes and configurations.

The signs may also include a variety of types (e.g., paper, plastic, stickers, window clings, etc.), allowing the user to display multiple signs where desired. FIG. 4 also shows one or more sheets 42 of pre-printed and blank customizable labels 38 (like the repositionable labels 38 shown in FIG. 3) that can be adhered to the sign(s) to tell customers what social networking services and web sites are accessible on the web site landing page. A user may select any desired preprinted labels to place on the sign(s), as well as creating customized labels from the blank labels. FIG. 4 also shows display hardware 44 that may be used when displaying the signs 32. The display hardware 44 may include any desired type of hanging hardware (adhesives, hooks, anchors, suction cups, pins, etc.) for hanging signs. The display hardware 44 may also include a base member that can be used with a sign 32 to create a free standing sign that may be placed on a table, counter, shelf, or other horizontal surface. Therefore, the user has the option of displaying signs on walls, windows, countertops, tables, etc. The kit may also include instructions 46. The instructions 46 includes information relating to kit registration, website content and layout configuration, sign configuration, and scanning instructions.

Following is a description of the operation of the techniques described above, from a user purchasing a kit, to a customer scanning a sign and accessing a web site landing page. As mentioned above, a user (e.g., a business owner or other entity) is provided with a generic, but unique, kit. The user can use any generic kit, since the user is not limited to using a kit that has been customized for the user's pre-existing web sites or accounts. By eliminating the need for a kit that is customized for a particular user, the kits can be mass produced as a low cost, and used by any user.

Once a user obtains a kit, the user accesses a web site and begins a registration process. The user can then configure a web site landing page (such as that described above and shown in FIGS. 2A-2D) that is associated with the respective kit. Thereafter, when a customer scans the machine readable medium on a sign from the kit, the customer will be directed to the landing page, which has been configured by the user. In addition to configuring the web site, the user can also customize the signs, as described above. For example, if the user wishes to emphasize certain social network services or web sites, the corresponding labels 38 can be applied to the sign 32.

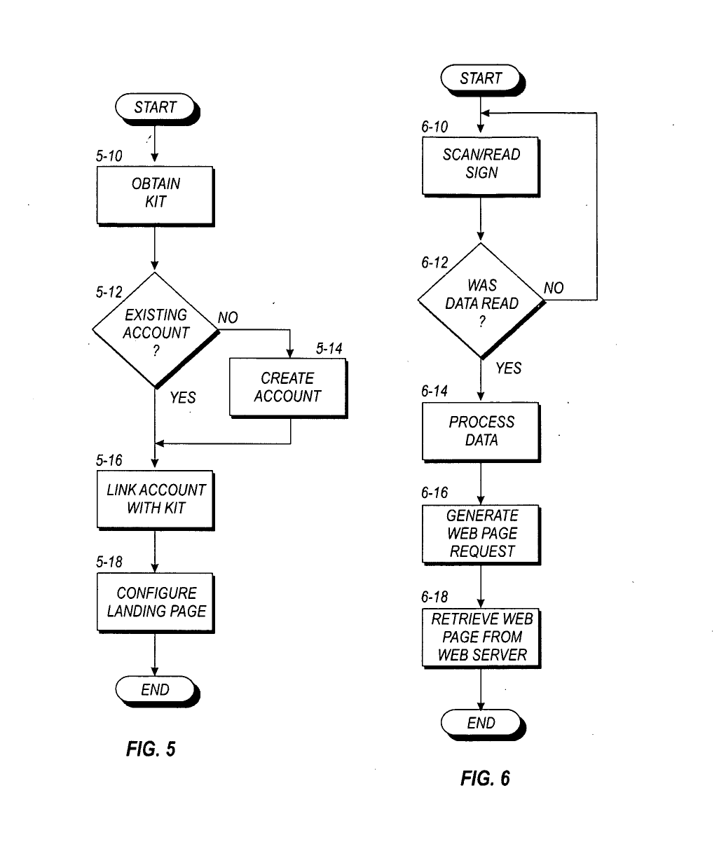

FIG. 5 is a flowchart illustrating an exemplary process for registering a kit and configuring a web site landing page. At step 5-10, a user obtains a kit, such as the kit shown in FIG. 4. If the user does not already have an account with the kit provider (step 5-12), an account is created at step 5-14. If the user already has an account, for example, if the user has previously registered another kit, the process proceeds to step 5-16. During the registration process, the user will be prompted to enter identification information provided with the kit, identifying which kit the user has purchased. At step 5-16, the user's account is linked with the particular kit purchased, so the machine readable medium in the signs will direct users to the appropriate landing page. At step 5-18, the user (i.e., administrator) configures the landing page. The user can configure the landing page layout and content (examples are shown in FIGS. 2A-2D). Thereafter, when a customer scans the machine readable medium, the customer will be directed to the landing page, and will view the content and layout defined by the administrator.

FIG. 6 is a flowchart illustrating an exemplary process of a customer (or other user) reading/scanning a sign and retrieving the web site landing page. At step 6-10, the customer uses a device (e.g., a smart phone) to read/scan the machine readable medium on a sign. In the example of an optical bar code, the user may use the device's camera hardware to scan the bar code. In the example of an NFC tag, the user places the device in the proximity of the NFC tag, and the NFC hardware in the device will read the NFC tag. If, at step 6-12, data was successfully read, the process proceeds to step 6-14, where the data is processed. If data was not successfully read, the process returns to step 6-10, and the user can attempt to read the medium again. The received data will include information relating to the address of the corresponding landing page.

A web browser in the device then generates a web page request for the respective web server (step 6-16), corresponding to the web site landing page. At step 6-18, the device retrieves the web site landing page from the web server (e.g., web server 16 of FIG. 1). At this point, the customer has access to any web content and links made available on the landing page. One benefit of the process described above is that a customer can be directed to various social media services with little effort, resulting in a higher acquisition rate versus when customers have to manually browse to each social media service.

As mentioned above with respect to the labels 38 of FIGS. 3 and 4, a label 38 may include information relating to a text messaging campaign. This information could also be printed on the sign itself, or be provided independent of the sign. Generally, a business can conduct a text messaging campaign by providing a short code text number, and a keyword that is unique to each kit. In the example shown in FIG. 3, the short text number is “12345” and the keyword for that particular kit is “ABCDE”. Multiple kits can share the same short text number, as long as the keywords are unique. In one example, for simplicity, the keyword can match the ending of the kit's unique URL. For example, if the unique URL of a particular kit is “www.[domainname].com/ABCDE”, then the text short code for that kit could be “ABCDE”.

Following is one example of how a kit user can use this feature. Like the examples above, the sign or label could include “Text ABCDE to 12345”, or something similar. When a customer texts “ABCDE” to 12345, an auto responder will reply with a message, as defined by the kit administrator, and a link to the web site landing page. The customer can then use the received link to access the web site landing page.

As mentioned above, providing kits, each with a unique machine readable medium, presents manufacturing challenges. Typically, when products are manufactured that include some form of machine readable medium (e.g., optical bar codes, near field communication (NFC) devices, etc.), the products are mass produced, with each product having the same information stored in the medium. However, there are potential applications of mass produced products, where each individual product has unique information stored in the respective medium. This complicates the manufacturing process.

For example, the exemplary kits described above each have unique information stored in the machine readable medium. In that example, for items with multiple machine readable medium, each medium stores the same, or related information. For a medium such as an optical bar code, the information is typically encoded in the bar code during a printing process. For a programmable medium such as an NFC tag, the information is programmed using a programming device. For applications where every product has identical information stored in an NFC tag, the NFC tags can be easily mass produced and programmed with the desired information. However, when each product has a medium with unique information, each product has to be individually programmed. In addition, for products with multiple machine readable medium (e.g., the sign 32 shown in FIG. 3) not only does each medium have to store the unique information, but the manufacturer has to ensure that each medium matches other medium on the product. In the example shown in FIG. 3, the sign 32 includes a bar code and an NFC tag. The bar code and NFC tag not only have to be unique from other signs, but they also have to be correctly paired, so that whether a user scans the bar code, or reads the NFC tag, the user will be directed to the desired information.

Referring to the sign 32 shown in FIG. 3, one way of manufacturing the sign is to print the bar code 34 with the desired information during the manufacturing process and attaching an unprogrammed NFC tag, to be programmed in a future step. Once the bar code is printed, the bar code can be used to program the NFC tag. In one example, an NFC programmer includes an optical scanner capable of reading the bar code 34. The NFC programmer uses the information read from the bar code to program the NFC tag. For example, if the bar code and NFC tag are designed to direct a user to a certain URL, the bar code will be encoded with the URL. The NFC programmer will read the bar code, and program the NFC tag to direct users to the URL that was encoded in the bar code.

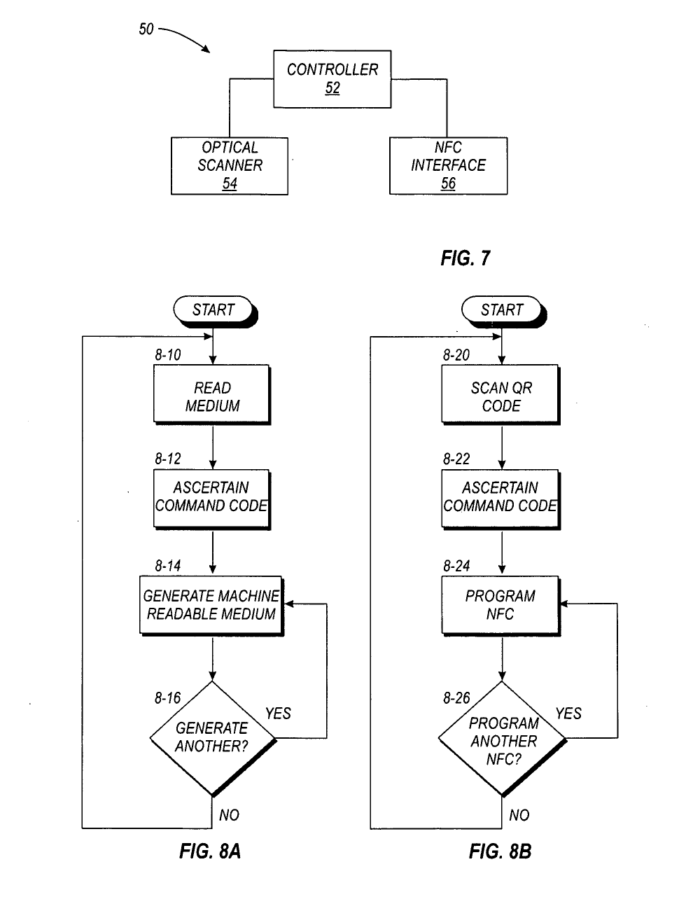

FIG. 7 is a block diagram of an apparatus for reading a first machine readable medium (in the above example, a QR code), and using the read information to generate/program a second medium (in the above example, an NFC tag). FIG. 7 shows a device 50 that can be used to read one machine readable medium, and use information read from the medium to generate/program a second machine readable medium. The device 50 includes a controller 52 coupled to an optical scanner 54 and an NFC interface 56. For clarity, FIG. 7 does not show various other components of the device, such as memory, power circuitry, a display, user interfaces, etc. Note that the device 50 can include any components used for reading and generating/programming any type of medium. In one example, the device 50 can be implemented using a smart phone having a camera, NFC hardware, and the appropriate software. Other examples are also possible.

As mentioned above, a device such as device 50, can be used to scan a bar code (such as a QR code), and use the received information to program one or more NFC tags. FIGS. 8A and 8B are flowcharts illustrating examples of processes that may be used to program one or more machine readable medium based on information read from other machine readable medium.

Generally, FIG. 8A illustrates an example of a process one or more machine readable medium being generated based on the reading of another machine readable medium. The read and generated medium can be the same or different types of medium. The process shown in FIG. 8A starts at step 8-10, where a first machine readable medium is read. As mentioned, any type of medium can be read, including bar codes, magnetic strips, RFID devices, NFC devices, etc. Similarly, printed text can be read using optical character recognition (OCR). Once the machine readable medium is read, the read information is used to ascertain the appropriate command code for the medium to be generated (step 8-12). Once the command code is ascertained, the second machine readable medium is generated (step 8-14). Any desired machine readable medium can be generated, including optical bar codes, magnetic strips, RFID devices, NFC devices, etc. Similarly, text can be printed. In some applications, multiple machine readable medium are generated using the same information. At step 8-16, the process determines whether another medium is to be programmed. If so, then the process proceeds back to step 8-14, where the next medium is generated. If not, the process starts over for the next unit.

FIG. 8B illustrates an example of a process similar to the process shown in FIG. 8A, where the process is described in the context of scanning a QR code, and programming one or more NFC tags. It should be understood that the same concept can be used to read and generate any desired types of machine readable medium.

The process shown in FIG. 8B starts at step 8-20, where a QR code is scanned. Once the QR code is scanned, the scanned information is used to ascertain the appropriate command code for the NFC tag (step 8-22). Once the command code is ascertained, the NFC tag is programmed (step 8-24). In some applications, multiple NFC tags are programmed with the same information. For example, in the kit 40 shown in FIG. 4, each sign 32A, 32B, 32C, etc., has an NFC tag that is programmed with the same information as the other signs in the kit. At step 8-26, the process determines whether another NFC tag is to be programmed. If so, then the process proceeds back to step 8-14, where the next NFC tag is programmed. If not, the process starts over for the next unit. Note that using a QR code to program an NFC tag is merely one example, and that any types of machine readable medium may be used. Also note that the process shown in FIG. 8B can be reversed, where an NFC tag is read, and the information read is used to generate a QR code. In another example, the medium scanned can be the same type as the medium generated/programmed. For example, the process can be used to generate a second QR code based on a scan of a first QR code.

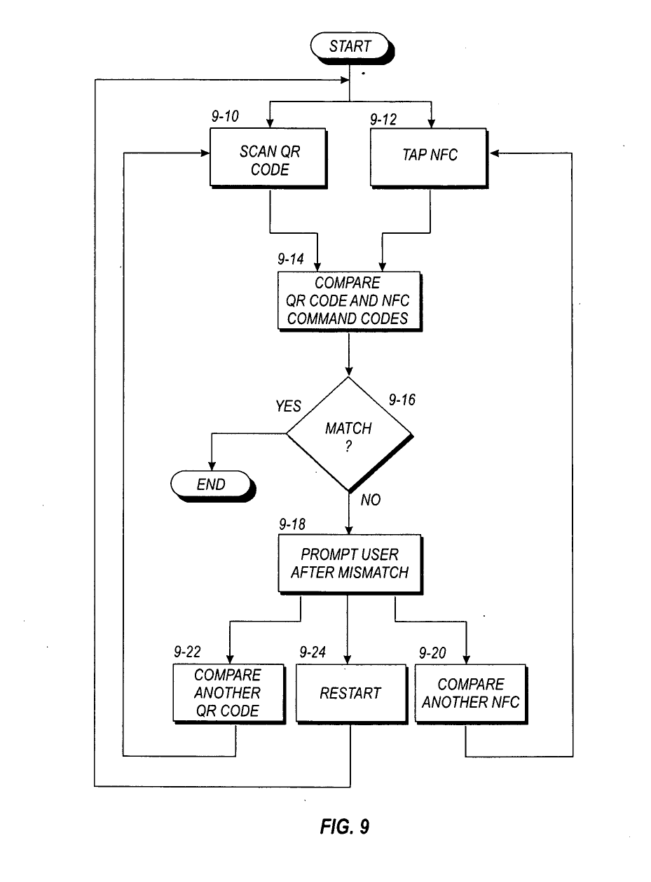

In addition to generating a second machine readable medium from a first, the techniques described above have other applications. For example, for product like signs described above, where multiple machine readable medium store related information, the techniques described above can be used for quality control, or to verify that the correct information is stored in each medium. FIG. 9 is a flowchart illustrating one example of a process used for quality control.

Generally, the process illustrated in FIG. 9 reads information from two or more related medium, and determines whether the information stored in each medium matches the other. By “matches”, it is not intended to mean that information stored on two more medium contain identical information, but rather, that the information be related or relate to a common piece of information. For example, in the example of the signs 32 shown in FIG. 4, the sign owner may want a user to be directed to the same (or similar) web site, whether they scan a bar code, read an NFC tag, type in a URL, etc., but the information stored in each medium may differ. In one example, the URL's stored in each medium may be unique (for tracking metrics, for example), but ultimately lead the user to the same web site. In one example, where the desired URL is “www.[domainname].com/ABCDE”, the QR code may store the URL “ www.[domainname].com/ABCDE/QR” the NFC tag may store the URL “www.[domainname].com/ABCDE/NFC”, and a text message reply link may include the URL “www.[domainname].com/ABCDE/text”. Even though the user is ultimately directed to the same URL, metrics can be tracked, letting the sign owner know which medium was used by users to get to the desired URL.

Referring again to FIG. 9, the process determines whether the information stored in each medium “matches” the others. If the information matches, each medium is storing the appropriate information. Like with FIG. 8B, for clarity, FIG. 9 will be described in the context of QR codes and NFC tags, although the techniques described apply to any desired medium.

The process begins with a QR code being scanned (step 9-10) and an NFC tag being read (step 9-12). Note that scanning the QR code and reading the NFC tag can happen in any desired order, or simultaneously. Once each machine readable medium is read, the information is compared (step 9-14). At step 9-16, the process determines if there is a match (what is intended by the term “match” is described above). In one example, a match or mismatch is detected automatically. In another example, the information read from each medium (e.g., command codes from each medium, the text of a URL, etc.) can be displayed, allowing a user to compare the information visually. In some examples, each medium will store related, but not necessarily identical information. In this case, the process analyzes the read information to determine if the information matches. If the information matches, the process ends.

If it is determined that there is a mismatch, is likely that one or both medium contain(s) wrong information. In the case of a mismatch, a user is prompted (step 9-18) and given several options. In the example of an automated system, the system can determine the next step (e.g., moving on the next product, re-reading, etc.) without waiting for user input. A first user option (step 9-20) is to compare another NFC tag. As mentioned above, in some examples, such as the kit shown in FIG. 4, a product has multiple NFC tags. Using this option, another of the NFC tags is read (step 9-12), and the process continues, as described above. A second option (step 9-22) is to compare another QR code. A third option (step 9-24) is to restart the process by reading the QR code and NFC tag again, in case the mismatch was a result of an scanning error. Alternatively, the process can restart and scan the medium in the next product to be tested. In another example, in response to a mismatch, the NFC tag can be reprogrammed using the information read from the QR code. When manufacturing products having unique information stored in the machine readable medium (such as with the kit shown in FIG. 4), the process described in FIG. 9 can be used to quickly and easily verify that the information stored in each medium is correct. If desired, logs can be generated that identify faulty products and identify which medium resulted in a mismatch. In another example, the process can include the steps of checking a database of command codes to see if a scanned command code has been used previously. This can prevent two or more products being produced that may result in a conflict. In another example, the information read from one or more machine readable medium can be displayed on a display device for a user. In another example, a bar code (e.g., a QR code) can be displayed on the display device for other devices to scan.

An example was given above of generating information for a second machine readable medium based on information read in a first medium. In another example, each machine readable medium can be generated in the same process. In this example, during the manufacturing of the product, a manual or automated command code is provided for a particular product being manufactured. From the provided command code, information for each machine readable medium is generated. Using this process, it will be assured that information on each medium will match the other(s), since they were generated based on the same command code.

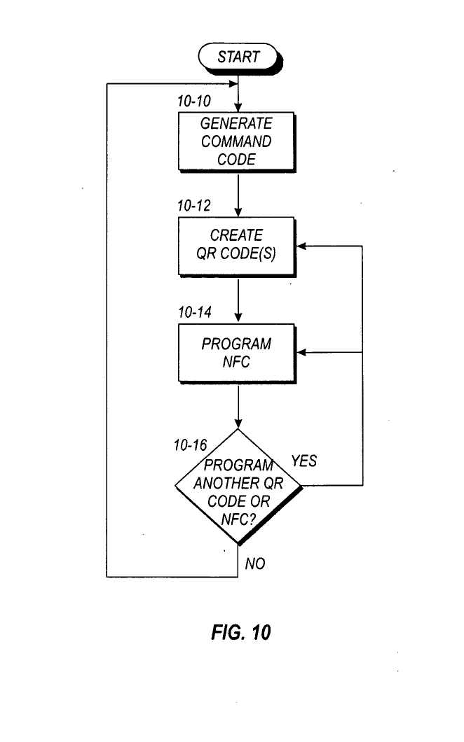

FIG. 10 is a flow chart illustrating a process for generating unique machine readable medium for a product. The process begins with step 10-10, where a command code is generated. A command code can be generated manually by a user, or may be automatically generated. Note that QR codes and NFC tags can include information to provide any desired type of function, including directing a user to a URL, populating emails and texts, providing payment information, etc. Once a command code has been generated, the command code can be used to create or program the machine readable medium. In this example, the command code will be used to generate a QR code(s) and program an NFC tag(s). At step 10-12, a QR code is created. This can be accomplished in any desired manner, but generally, may involve a printing process (e.g., during the creation of the product itself, or by printing a label to be adhered to a product, etc.). At step 10-14 an NFC tag is programmed, using the command code. Since the NFC tag and QR code are created/programmed based on the same information (provided in step 10-10), the information stored in each medium will match. At step 10-16, the process determines if more QR codes or NFC tags should be programmed. If so, the process proceeds back to step 10-12 and/or step 10-14, and another QR code and/or NFC tag is programmed. If not, the process starts over for the next unit. Note that the generation of the QR code (step 10-12) and programming of the NFC tag (step 10-14) can be performed in any desired order, or can be performed simultaneously. Similarly, multiple QR codes can be printed simultaneously, and/or multiple NFC tags can be programmed simultaneously.

In some of the examples above (for generating/programming machine readable medium), the processes were described in the context of QR codes and NFC tags. Note that the same process applies regardless of the type of machine readable medium used. Also note that, the processes described above have numerous applications, in addition to the examples provided. In one example, a machine readable medium is generated/programmed based on textual information read using optical character recognition (OCR). In this example, after scanning the text, a machine readable medium is generated using the scanned textual information. The generated medium may contain any desired information related to the scanned text. For example, if the textual information includes an internet URL, the generated medium may include the same or a related URL. In another example, the techniques described above can be used by stores, warehouses, etc. of managing inventory (for example, by scanning product bar codes and comparing the scanned information with information stored on an NFC tag on a shelf, etc.). In another example, a product such as a magazine can include an NFC tag, which is programmed with information based on an OCR scan of the delivery address, or based on the reading of a bar code found near the delivery address.

In the preceding detailed description, the disclosure is described with reference to specific exemplary embodiments thereof. Various modifications and changes may be made thereto without departing from the broader spirit and scope of the disclosure as set forth in the claims. The specification and drawings are, accordingly, to be regarded in an illustrative rather than a restrictive sense.

What is claimed is:

1. A method of generating a machine readable medium comprising:
reading information from a first machine readable medium; and
generating a second machine readable medium using the information read from the first machine readable medium, wherein the second machine readable medium is generated to include information relating to the information read from the first machine readable medium.

2. The method of claim 1, wherein the first machine readable medium is an optical bar code.

3. The method of claim 2, wherein the second machine readable medium is an optical bar code.

4. The method of claim 2, wherein the second machine readable medium is an NFC tag.

5. The method of claim 1, wherein the first machine readable medium is read using optical character recognition.

6. The method of claim 1, wherein the first machine readable medium and the second machine readable medium are formed as a part of a display sign.

7. The method of claim 6, further comprising:
providing a second display sign; and
generating a third machine readable medium using the information read from the first machine readable medium, wherein the third machine readable medium is formed as a part of the second display sign.

8. The method of claim 1, further comprising generating a third machine readable medium using the information read from the first machine readable medium.

9. A method of programming a near field communication (NFC) tag comprising:
reading information from an optical barcode relating to the URL of a website; and
using the information read from the optical barcode to program an NFC tag with information relating to the URL of the website.

10. The method of claim 9, wherein the optical bar code is a QR code.

11. The method of claim 9, wherein the optical barcode and the NFC tag are formed as a part of a display sign.

12. The method of claim 11, further comprising:
providing a second display sign having a second NFC tag; and
programming the second NFC tag using the information read from the optical barcode.

13. The method of claim 11, further comprising programming the NFC tag such that it can be distinguished whether a user is directed to the website via the optical bar code or the NFC tag.

14. A method of verifying the accuracy of information stored on a machine readable medium comprising:
reading information from a first machine readable medium;
reading information from a second machine readable medium;
comparing the information read from the first machine readable medium and the second machine readable medium; and
determining whether the information read from the first machine readable medium and the information read from the second machine readable medium relate to a common piece of information.

15. The method of claim 14, wherein the second machine readable medium is a programmable device.

16. The method of claim 15, further comprising reprogramming the second machine readable medium when it is determined that the information read from the first machine readable medium and the information read from the second machine readable medium does not relate to the common piece of information.

17. The method of claim 14, further comprising prompting a user to take an action when it is determined that the information read from the first machine readable medium and the information read from the second machine readable medium does not relate to the common piece of information.

18. The method of claim 14, wherein the common piece of information is an internet address.

19. The method of claim 14, wherein the first machine readable medium and the second machine readable medium are the same type of medium.

20. The method of claim 14, wherein the first machine readable medium and the second machine readable medium are different types of machine readable medium.

21. The method of claim 20, wherein the first machine readable medium is an optical bar code and the second machine readable medium is an NFC tag.

22. A method of generating a machine readable medium comprising:
using optical character recognition (OCR) to scan textual information; and
generating a machine readable medium using the scanned textual information, wherein the machine readable medium is generated to include information relating to the scanned textual information.
